(19) United States
(12) Patent Application Publication
(10) Pub. No.: US 2017/0262853 A1
(43) Pub. Date: Sep. 14, 2017

(54) METHOD AND SYSTEM FOR BIOMETRIC CONFIRMATION OF SUSPECT TRANSACTIONS

(71) Applicant: Mastercard International Incorporated, Purchase, NY (US)

(72) Inventors: Gregory WILLIAMSON, Stamford, CT (US); Laurie Ann NICOLETTI, White Plains, NY (US); Janet Marie SMITH, Ballwin, MO (US)

(73) Assignee: Mastercard International Incorporated, Purchase, NY (US)

(21) Appl. No.: 15/457,087

(22) Filed: Mar. 13, 2017

Related U.S. Application Data
(60) Provisional application No. 62/307,780, filed on Mar. 14, 2016.

(51) Int. Cl. G06Q 20/40; H04L 29/08

(52) U.S. Cl. CPC G06Q 20/4016; H04L 67/32; G06Q 20/40145; G06Q 2220/10

(57) ABSTRACT

A method for confirmation of a suspect transaction includes: storing device profiles, each including a device identifier and registered biometric data; receiving a confirmation request from a third party entity including a specific device identifier and a transaction identifier and data values associated with a suspect transaction; identifying a specific device profile that includes the specific device identifier; transmitting a biometric request to the computing device related to the specific device profile, the biometric request including the transaction identifier and data values; receiving a confirmation message from the computing device including confirmation of the suspect transaction, the transaction identifier, and supplied biometric data; verifying the supplied biometric data as being equivalent to the registered biometric data in the specific device profile; and transmitting a confirmation response to the third party entity including the indicated confirmation, an indication of positive verification of the biometric data, and the transaction identifier.

### FIELD

The present disclosure relates to the confirmation of suspect transactions using biometric data, specifically the pushing of a notification to a computing device associated with an electronic transaction suspect of involving fraud and the receipt of biometric data therefrom for confirmation of the transaction from an authorized and identifiable individual.

### BACKGROUND

The number of electronic payment transactions processed throughout the world each day is in the billions. Most of the time, these transactions are genuine, conducted between an authorized entity and a legitimate merchant. However, each day there are thousands of fraudulent transactions that are attempted, and sometimes successfully conducted, much to the detriment of financial institutions, merchants, and consumers. Fraudulent transactions often result in a loss of income for the merchant and financial institution, and can lead to a loss of money and other additional headaches, such as having to cancel old payment instruments, order new ones, update billing information with various merchant accounts, etc.

As a result, many payment networks and financial institutions have developed methods for identifying electronic payment transactions that are suspected of involving fraud. When a transaction is suspected for fraud, a financial institution will make a decision on the transaction (e.g., to approve or deny, based on internal rules and criteria regarding the likelihood of fraud) and then immediately contact the entity associated with the transaction account to find out if the transaction was a genuine transaction or involved fraud. In many cases, the financial institution will call a registered computing device or send a short message service (SMS) message to the registered computing device, where the entity may respond and either confirm or deny that the transaction was authorized.

Unfortunately, such systems often involve a significant investment by financial institutions to implement, due to the infrastructure required for telephone or messaging systems, as well as the large expense necessary to operate and maintain such systems. For some financial institutions, particularly local banks and credit unions, such investments may not be feasible, and may not be cost-effective. In addition, such systems may also be compromised for the same reason that the underlying transaction is suspected. For example, if a payment card is stolen and used in a transaction that is, as a result, suspected of fraud, the computing device tied to the account may also have been stolen, particularly in instances where the computing device itself may be used as a payment instrument (e.g., via an electronic wallet, for example). In such cases, the telephone call or SMS message requesting confirmation of the suspected transaction may go straight to the nefarious party, who may confirm the transaction and enable the fraudulent transaction to be processed.

Thus, there is a need for a technical solution to confirm payment transactions that are suspected of fraud in a manner where the confirmation can be authenticated to an authorized user associated with the transaction account. In addition, there is a need for a technical solution to enable such confirmations using a service that can be implemented by financial institutions without modification to existing infrastructure and at a minimal expense, to enable the confirmation of suspected transactions for financial institutions that may be unable to implement existing systems.

### SUMMARY

The present disclosure provides a description of systems and methods for confirming suspected transactions using biometric data.

A method for confirmation of a suspect transaction using biometric data includes: storing, in a device database of a processing server, a plurality of device profiles, wherein each device profile includes a structured data set related to a computing device including at least a device identifier and registered biometric data; receiving, by a receiving device of the processing server, a first data signal, from a third party entity, superimposed with a confirmation request, wherein the confirmation request includes at least a specific device identifier and transaction data associated with a suspected fraudulent payment transaction, the transaction data including at least a transaction identifier and additional transaction data values; executing, by a querying module of the processing server, a query on the device database to identify a specific device profile where the included device identifier corresponds to the specific device identifier; electronically transmitting, by a transmitting device of the processing server, a first data signal, to a computing device related to the identified specific device profile based on the specific device identifier, that is superimposed with a biometric request, wherein the biometric request includes at least the transaction identifier and additional transaction data values; receiving, by the receiving device of the processing server, a second data signal, from the computing device, superimposed with a confirmation message, the confirmation message indicating confirmation of the suspected fraudulent payment transaction and including at least the transaction identifier and supplied biometric data associated with a user of the computing device; verifying, by a verification module of the processing server, the supplied biometric data as being equivalent to the registered biometric data stored in the specific device profile; and electronically transmitting, by the transmitting device of the processing server, a second data signal, to the third party entity, superimposed with a confirmation response, wherein the confirmation response includes at least the indicated confirmation of the suspected fraudulent payment transaction, an indication of positive verification of the supplied biometric data, and the transaction identifier.

A system for confirmation of a suspect transaction using biometric data includes: a verification module of a processing server; a device database of the processing server configured to store a plurality of device profiles, wherein each device profile includes a structured data set related to a computing device including at least a device identifier and registered biometric data; a receiving device of the processing server configured to receive a first data signal, from a third party entity, superimposed with a confirmation request, wherein the confirmation request includes at least a specific device identifier and transaction data associated with a suspected fraudulent payment transaction, the transaction data including at least a transaction identifier and additional transaction data values; a querying module of the processing server configured to execute a query on the device database to identify a specific device profile where the included device identifier corresponds to the specific device identifier; and a transmitting device of the processing server configured to electronically transmit a first data signal, to a computing device related to the identified specific device profile based on the specific device identifier, that is superimposed with a biometric request, wherein the biometric request includes at least the transaction identifier and additional transaction data values. The receiving device of the processing server is further configured to receive a second data signal, from the computing device, superimposed with a confirmation message, the confirmation message indicating confirmation of the suspected fraudulent payment transaction and including at least the transaction identifier and supplied biometric data associated with a user of the computing device. The verification module of the processing server is configured to verify the supplied biometric data as being equivalent to the registered biometric data stored in the specific device profile. The transmitting device of the processing server is further configured to electronically transmit a second data signal, to the third party, entity superimposed with a confirmation response, wherein the confirmation response includes at least the indicated confirmation of the suspected fraudulent payment transaction, an indication of positive verification of the supplied biometric data, and the transaction identifier.

### BRIEF DESCRIPTION OF THE DRAWING FIGURES

The scope of the present disclosure is best understood from the following detailed description of exemplary embodiments when read in conjunction with the accompanying drawings. Included in the drawings are the following figures:

FIG. 1 is a block diagram illustrating a high level system architecture for the biometric confirmation of payment transactions suspected of fraud in accordance with exemplary embodiments.

FIG. 2 is a block diagram illustrating the processing server of FIG. 1 for the biometric confirmation of suspected transactions in accordance with exemplary embodiments.

FIG. 3 is a flow diagram illustrating a process for confirming suspected payment transactions via biometric data using the system of FIG. 1 in accordance with exemplary embodiments.

FIG. 4 is a flow diagram illustrating a process for confirming a suspected payment transaction via authentication of a user using biometric data and authentication of an associated computing device using the processing server of FIG. 2 in accordance with exemplary embodiments.

FIG. 5 is a flow chart illustrating an exemplary method for confirmation of a suspect transaction using biometric data in accordance with exemplary embodiments.

FIG. 6 is a flow diagram illustrating the processing of a payment transaction in accordance with exemplary embodiments.

FIG. 7 is a block diagram illustrating a computer system architecture in accordance with exemplary embodiments.

Further areas of applicability of the present disclosure will become apparent from the detailed description provided hereinafter. It should be understood that the detailed description of exemplary embodiments are intended for illustration purposes only and are, therefore, not intended to necessarily limit the scope of the disclosure.

### DETAILED DESCRIPTION

### Glossary of Terms

Payment Network—A system or network used for the transfer of money via the use of cash-substitutes for thousands, millions, and even billions of transactions during a given period. Payment networks may use a variety of different protocols and procedures in order to process the transfer of money for various types of transactions. Transactions that may be performed via a payment network may include product or service purchases, credit purchases, debit transactions, fund transfers, account withdrawals, etc. Payment networks may be configured to perform transactions via cash-substitutes, which may include payment cards, letters of credit, checks, transaction accounts, etc. Examples of networks or systems configured to perform as payment networks include those operated by MasterCard®, VISA®, Discover®, American Express®, PayPal®, etc. Use of the term “payment network” herein may refer to both the payment network as an entity, and the physical payment network, such as the equipment, hardware, and software comprising the payment network.

Payment Rails—Infrastructure associated with a payment network used in the processing of payment transactions and the communication of transaction messages and other similar data between the payment network and other entities interconnected with the payment network that handles thousands, millions, and even billions of transactions during a given period. The payment rails may be comprised of the hardware used to establish the payment network and the interconnections between the payment network and other associated entities, such as financial institutions, gateway processors, etc. In some instances, payment rails may also be affected by software, such as via special programming of the communication hardware and devices that comprise the payment rails. For example, the payment rails may include specifically configured computing devices that are specially configured for the routing of transaction messages, which may be specially formatted data messages that are electronically transmitted via the payment rails, as discussed in more detail below.

Transaction Account—A financial account that may be used to fund a transaction, such as a checking account, savings account, credit account, virtual payment account, etc. A transaction account may be associated with a consumer, which may be any suitable type of entity associated with a payment account, which may include a person, family, company, corporation, governmental entity, etc. In some instances, a transaction account may be virtual, such as those accounts operated by PayPal®, etc.

Merchant—An entity that provides products (e.g., goods and/or services) for purchase by another entity, such as a consumer or another merchant. A merchant may be a consumer, a retailer, a wholesaler, a manufacturer, or any other type of entity that may provide products for purchase as will be apparent to persons having skill in the relevant art. In some instances, a merchant may have special knowledge in the goods and/or services provided for purchase. In other instances, a merchant may not have or require any special knowledge in offered products. In some embodiments, an entity involved in a single transaction may be considered a merchant. In some instances, as used herein, the term “merchant” may refer to an apparatus or device of a merchant entity.

Issuer—An entity that establishes (e.g., opens) a letter or line of credit in favor of a beneficiary, and honors drafts drawn by the beneficiary against the amount specified in the letter or line of credit. In many instances, the issuer may be a bank or other financial institution authorized to open lines of credit. In some instances, any entity that may extend a line of credit to a beneficiary may be considered an issuer. The line of credit opened by the issuer may be represented in the form of a payment account, and may be drawn on by the beneficiary via the use of a payment card. An issuer may also offer additional types of payment accounts to consumers as will be apparent to persons having skill in the relevant art, such as debit accounts, prepaid accounts, electronic wallet accounts, savings accounts, checking accounts, etc., and may provide consumers with physical or non-physical means for accessing and/or utilizing such an account, such as debit cards, prepaid cards, automated teller machine cards, electronic wallets, checks, etc.

### System for Biometric Confirmation of Suspect Transactions

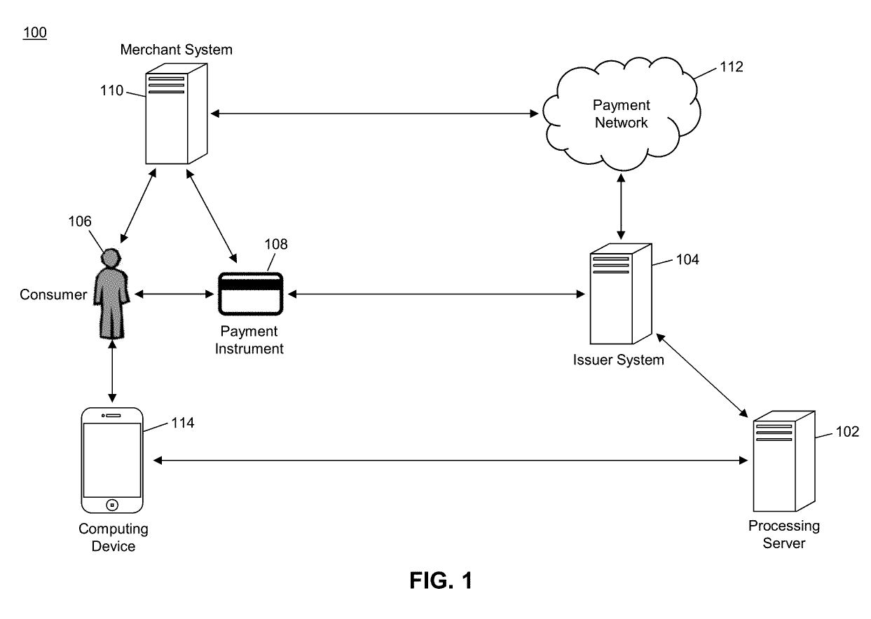

FIG. 1 illustrates a system 100 for the confirmation of electronic payment transactions suspected of fraud using biometric data.

The system 100 may include a processing server 102. The processing server 102, discussed in more detail below, may be configured to receive confirmation of an electronic payment transaction suspected of fraud using biometric data. The processing server 102 may be in communication with an issuer system 104. The issuer system 104 may be a computing system operated by or on behalf of an issuing financial institution, such as an issuing bank, configured to issue transaction accounts for use in funding payment transactions and process payment transactions funded by the issued transaction accounts.

In the system 100, the issuer system 104 may issue a transaction account to a consumer 106 for use in funding payment transactions. As will be apparent to persons having skill in the relevant art, the consumer 106 may be an entity suitable for receipt of a transaction account and use thereof in funding payment transactions, such as an individual, a group of individuals, a business entity, etc. As part of the issuance of the transaction account, the issuer system 104 may issue a payment instrument 108 to the consumer 106. The payment instrument 108 may be any type of payment instrument suitable for conveying payment details for a transaction account to a merchant system 110 as part of the initiating of a payment transaction. The payment instrument 108 may be, for example, a credit card, debit card, check, virtual payment card, electronic wallet, etc. Payment details that may be conveyed via the payment instrument 108 may include at least a primary account number and any other data associated with a transaction account that may be provided to a merchant system 110 for use in a payment transaction, such as a transaction counter, payment cryptograms, consumer name, etc.

Prior to the conducting of payment transactions, the consumer 106 may register with the processing server 102 for use of the biometric confirmation service. In some embodiments, the consumer 106 may register with the processing server 102 via the issuer system 104. In other embodiments, the consumer 106 may register directly with the processing server 102. Registration of the consumer 106 may involve the registration of a computing device 114 and consumer biometric data. Registration of the computing device 114 may include the electronic transmission of a device identifier associated with the computing device 114 to the processing server 102, either directly or via the issuer system 104. The device identifier may be a unique identification value associated with the computing device 114, such as a media access control address, internet protocol address, telephone number, identification value, username, registration number, serial number, etc. The computing device 114 may be any type of computing device 114 suitable for capturing biometric data from a consumer 106, such as a desktop computer, laptop computer, notebook computer, tablet computer, cellular phone, smart phone, smart watch, smart television, smart camera, voice recorder, wearable computing device, implantable computing device, etc.

The consumer biometric data may be biometric data read from and associated with the consumer 106 that may be used in verification of the identity of the consumer 106 in future communications. Biometric data may include, for example, fingerprint scan, retinal scan, facial scan, voice recognition, etc. Biometric data may be captured by a suitable device attached to or integrated with the computing device 114, such as a camera, microphone, digital imager, etc. In some instances, the biometric data may be unique to the consumer 106 such that no other individual using the same capturing device may have the same biometric data. The captured biometric data may be electronically transmitted to the processing server 102 and registered with the transaction account issued to the consumer 106.

In some embodiments, multiple consumers 106 and/or computing devices 114 may be registered to a transaction account with the processing server 102. For example, if multiple payment instruments 108 are issued for the transaction account, each consumer 106 that receives a payment instrument may have their biometric data registered. Similarly, if a consumer 106 may use multiple computing devices 114, each may be registered with the transaction account for use in confirming suspected transactions and capturing biometric data related thereto.

To conduct a payment transaction, the consumer 106 may present the payment instrument 108 to the merchant system 110 to convey the payment details encoded therein to the merchant system 110. The merchant system 110 may read the payment details from the payment instrument 108 using traditional methods and systems, which may include, for example, reading payment details encoded on a magnetic stripe, reading payment details encoded in a machine-readable code displayed by the payment instrument 108, receiving the payment details in a data signal electronically transmitted using near field communication, etc. The merchant system 110, which may be any type of computing system suitable for performing the functions of a merchant involved in a payment transaction, such as a point of sale system, may electronically transmit the payment details and other transaction data to a payment network 112 for processing of the payment transaction. In some instances, the transaction data (e.g., including the payment details) may be electronically transmitted to the payment network 112 via payment rails associated therewith, and may be transmitted via one or more intermediate entities, such as an acquiring financial institution and/or a gateway processor.

In some embodiments, the transaction data may be included in a transaction message, which may be electronically transmitted to the payment network 112 for the payment transaction. The transaction message may be generated by the merchant system 110 or by an intermediate entity (e.g., an acquiring financial institution) using the transaction data provided by the merchant system 110. Transaction messages may be specially formatted data messages that are formatted pursuant to one or more standards governing the exchange of financial transaction messages, such as the International Organization of Standardization's ISO 8583 standard, for use in conveying transaction data across payment rails as part of the processing of a payment transaction. Transaction messages may include a message type indicator, which may be indicative of a type of the payment transaction, such as an authorization request or authorization response. Transaction messages may also include a plurality of data elements, which may be configured to store data for use in the processing of the payment transaction, such as a primary account number, transaction amount, transaction time, transaction date, geographic location, merchant data, issuer data, acquirer data, consumer data, product data, reward data, loyalty data, offer data, etc. In some instances, transaction messages may include one or more bitmaps, which may include data indicating the data elements included in the transaction messages and the data stored therein.

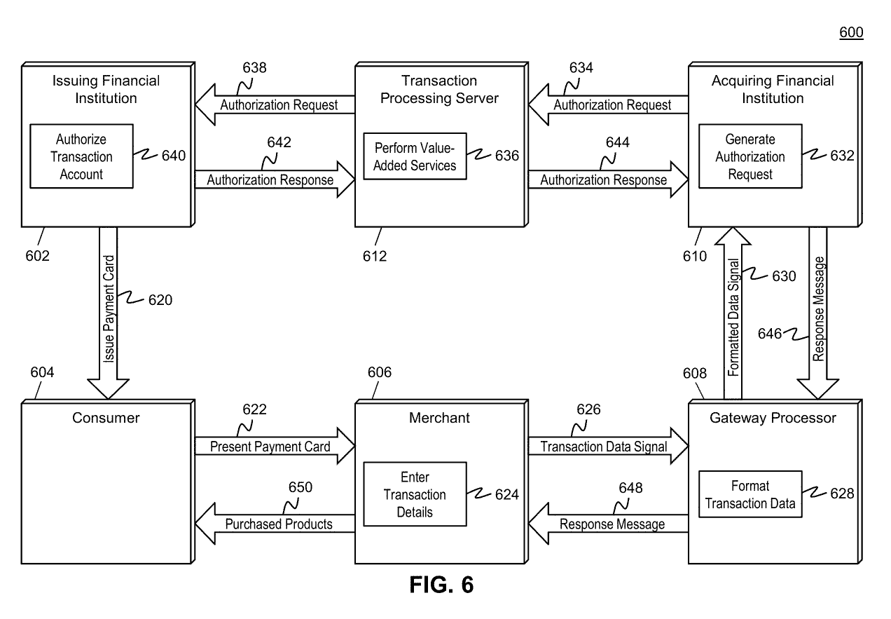

The payment network 112 may receive a transaction message for the payment transaction that includes a message type indicator indicating an authorization request and a plurality of data elements including a data element configured to store the primary account number read from the payment instrument 108, and additional data elements configured to store any additional transaction data. The payment network 112 may perform value-added services on behalf of the issuer system 104, such as fraud scoring, and may then forward the authorization request to the issuer system 104 using the payment rails associated with the payment network 112. The issuer system 104 may receive the authorization request and determine approval or denial of the payment transaction using traditional methods. Additional information regarding the generation, formatting, and exchange of transaction messages and the traditional processing of payment transactions is discussed in more detail below with respect to the process 600 illustrated in FIG. 6.

The issuer system 104 may receive the authorization request for the payment transaction and may identify the transaction as being a suspect transaction. The identification may be based on the transaction data stored in the data elements included therein, using traditional methods and systems for identifying the likelihood of fraud in an electronic payment transaction. For instance, the issuer system 104 may use a fraud score provided by the payment network 112 or may calculate a fraud score for the payment transaction, where the fraud score may be above a threshold for determining that a payment transaction is suspected of fraud. In an example, the issuer system 104 may identify that a geographic location of the payment transaction is far from prior transactions conducted by the consumer 106, which may indicate that the transaction is fraudulent.

For suspected transactions, the issuer system 104 may electronically transmit a data signal to the processing server 102 that is superimposed or otherwise encoded with a confirmation request, for seeking confirmation of the suspected transaction. The confirmation request may include at least a transaction identifier for the payment transaction, one or more pieces of transaction data for confirmation by the consumer 106, and the device identifier associated with each computing device 114 registered with the transaction account. The transaction identifier may be a unique value associated with the payment transaction, such as an identification number. In some instances, the transaction identifier may be parsed from a data element included in the authorization requested received from the payment network 112. In some cases, the data signal may be electronically transmitted to the processing server 102 via the payment rails associated with the payment network 112. In some such cases, the processing server 102 may be a part of the payment network 112. In other cases, the issuer system 104 may electronically transmit the data signal using an alternative, suitable communication network, such as a local area network, wireless area network, radio frequency network, cellular communication network, the Internet, etc.

The processing server 102 may receive the confirmation request and may then electronically transmit a data signal to the computing device 114 associated with each device identifier included in the confirmation request. In an exemplary embodiment, the data signal may be transmitted as a push notification to the computing device 114, which may be immediately received by the computing device 114, and the user of the computing device 114 alerted. The data signal may be superimposed or otherwise encoded with a biometric request. The biometric request may include the transaction identifier, and may also include the one or more pieces of transaction data, which may be displayed or otherwise conveyed to the consumer 106 using a display device or other suitable device (e.g., microphone) of the computing device 114. The one or more pieces of transaction data may include, for example, a transaction amount, merchant name, transaction time, and currency type for the transaction, which may assist the consumer 106 in identifying the suspected transaction. For instance, the computing device 114 may prompt the consumer 106, asking “Did you conduct a payment transaction at Main Street Café at 7:04 PM today for $6.72?”

The consumer 106 may indicate a confirmation or denial of the payment transaction using a suitable input device of the computing device 114. Input devices may include, for example, a keyboard, mouse, touch screen, click wheel, scroll wheel, microphone, camera, stylus, etc. The consumer 106 may also be prompted by the computing device 114 to supply biometric data. The computing device 114 may capture the consumer's biometric data using suitable capturing mechanisms. The computing device 114 may then electronically transmit a data signal back to the processing server 102 that is superimposed with the consumer's indication of approval or denial of the suspected transaction, and their captured biometric data.

The processing server 102 may verify the captured biometric data by comparing it against the biometric data provided by the consumer 106 during the registration process. If the captured biometric data does not match the registered biometric data, then the verification may be unsuccessful. The processing server 102 may inform the issuer system 104 accordingly, which may then deny the payment transaction or, if the payment transaction was already processed, may initiate a chargeback or other reversal of the payment transaction. In some cases, if the consumer 106 indicates denial of the payment transaction, the issuer system 104 may deny the payment transaction or process a reversal regardless of success of the verification of the biometric data.

If the captured biometric data is verified as matching the registered biometric data, then the processing server 102 may electronically transmit a data signal to the issuer system 104 that is superimposed or otherwise encoded with a confirmation message. The confirmation message may include the transaction identifier associated with the payment transaction, as well as the consumer's indication of approval of the payment transaction and an indication that verification of the biometric data was successful. In some embodiments, the issuer system 104 may not receive or possess the registered or captured biometric data. In such embodiments, the issuer system 104 may retain from possession of biometric data for consumer privacy, which may enable operation by the issuer system 104 using traditional computing systems that may not enable the storage and usage of biometric data. With the suspected transaction confirmed, and consumer 106 verified as genuine via the biometric data, the issuer system 104 may approve the payment transaction, or, if the transaction was previously approved, may proceed through traditional clearing and settlement processes, without challenging the authenticity of the payment transaction.

In some embodiments, the issuer system 104 may be comprised of multiple computing devices and/or systems. For instance, as discussed above, the issuer system 104 may be comprised of a single computing system configured to perform the functions discussed herein. In another example, the issuer system 104 may be comprised of a first computing system and a second computing system. In the example, the first computing system may be configured to identify suspect transactions and electronically transmit the confirmation requests to the processing server 102, and the second computing system may be configured to communicate with the computing device 114 and relay data between the computing device 114 and the processing server 102, including the communications discussed above. For instance, the first computing system may electronically transmit a confirmation request to the processing server 102, the processing server 102 may then inform the second computing system that biometric data must be captured, the second computing system may communicate with the computing device 114 to prompt for biometric data from the consumer 106, the second computing system may encrypt the biometric data and forward it to the processing server 102 where the processing server may validate the biometric data as discussed above, the processing server 102 may provide the result of the validation to the second computing system, and then the second computing system may inform the first computing system of the validation result. In some cases, the processing server 102 may inform the first computing system of the result directly.

Using the methods and systems discussed herein, the processing server 102 may accomplish the confirmation of payment transactions that are suspected as fraud using biometric data to ensure that the entity that confirms the transaction is authorized to make such an assertion. By using biometric data, the processing server 102 may ensure that a nefarious party that may compromise the computing device 114 may not be able confirm fraudulent transactions that are conducted subsequent to the compromise, which may prohibit the unauthorized usage of the consumer's transaction account. In addition, the use of a third party service operated by the processing server 102 may ensure that issuing financial institutions are able to receive authentication confirmation of suspected payment transactions without having to modify existing systems to store and use biometric data, engage in two way communications with computing devices 114, and perform other functions that may require significant modification to issuer systems and infrastructure. As a result, the processing server 102 may provide for a useful technological service to issuer systems 104 that is more beneficial than existing systems, and with less expense and expenditure by issuer systems 104.

In some embodiments, the processing server 102 may also be configured to verify the authenticity of the computing device 114 itself, in addition to verifying the consumer 106 providing the confirmation. In such embodiments, the processing server 102 and computing device 114 may each possess an encryption key in a key pair. The computing device 114 may generate an encryption value using its encryption key, which may be conveyed to the processing server 102 with the captured biometric data and confirmation provided by the consumer 106. The processing server 102 may generate its own encryption value using its encryption key, which may be compared to the encryption value provided by the computing device 114. The processing server 102 may thus verify the authenticity of the computing device 114, as any other computing device may not possess the corresponding encryption key in the key pair that had been provided to the computing device 114 during registration of the transaction account and computing device 114. In some instances, the key pair may include a public key and a private key, with the private key being provisioned to the computing device 114 using traditional methods. In some cases, the processing server 102 and computing device 114 may each possess a private key of a key pair, with the other possessing the corresponding public key. In such cases, the encryption value that is generated by each may be a shared secret generated using the private key from one pair and the public key from the other pair. Additional methods for the use of key cryptography for the verification of a computing device 114 will be apparent to persons having skill in the relevant art.

### Processing Server

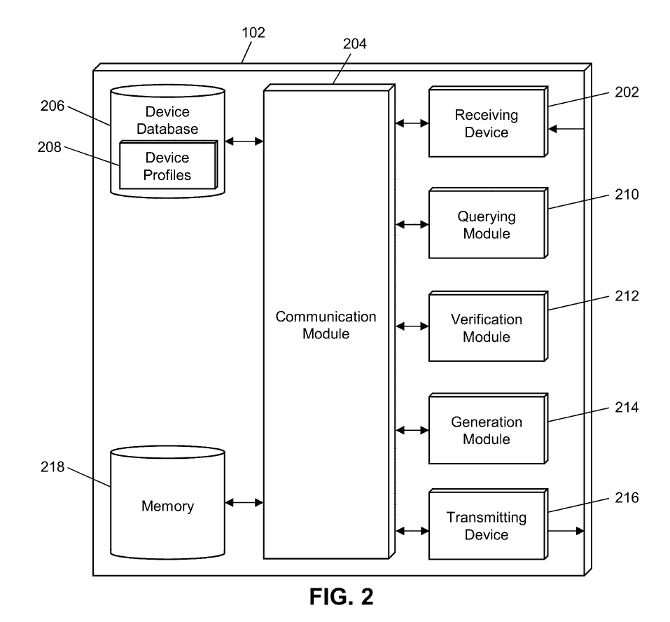

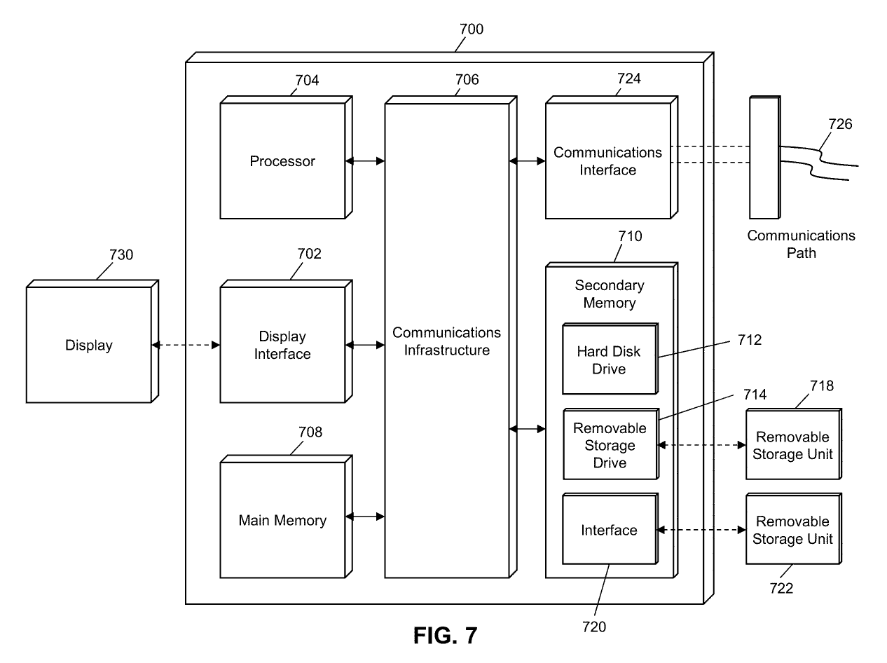

FIG. 2 illustrates an embodiment of the processing server 102 of the system 100. It will be apparent to persons having skill in the relevant art that the embodiment of the processing server 102 illustrated in FIG. 2 is provided as illustration only and may not be exhaustive to all possible configurations of the processing server 102 suitable for performing the functions as discussed herein. For example, the computer system 700 illustrated in FIG. 7 and discussed in more detail below may be a suitable configuration of the processing server 102.

The processing server 102 may include a receiving device 202. The receiving device 202 may be configured to receive data over one or more networks via one or more network protocols. In some embodiments, the receiving device 202 may be configured to receive data over the payment rails, such as using specially configured infrastructure associated with payment networks 112 for the transmission of transaction messages that include sensitive financial data and information. In some instances, the receiving device 202 may also be configured to receive data from issuer systems 104, computing devices 114, and other entities via alternative networks, such as the Internet. In some embodiments, the receiving device 202 may be comprised of multiple devices, such as different receiving devices for receiving data over different networks, such as a first receiving device for receiving data over payment rails and a second receiving device for receiving data over the Internet. The receiving device 202 may receive electronically transmitted data signals, where data may be superimposed or otherwise encoded on the data signal and decoded, parsed, read, or otherwise obtained via receipt of the data signal by the receiving device 202. In some instances, the receiving device 202 may include a parsing module for parsing the received data signal to obtain the data superimposed thereon. For example, the receiving device 202 may include a parser program configured to receive and transform the received data signal into usable input for the functions performed by the processing device to carry out the methods and systems described herein.

The receiving device 202 may be configured to receive data signals electronically transmitted by issuer systems 104 and/or computing devices 114 that are superimposed or otherwise encoded with registration data. Registration data may include at least a device identifier associated with a computing device 114 and registered biometric data associated with a consumer 106 for a transaction account. In some instances, multiple data signals superimposed with registration data for a transaction account may be received by the receiving device 202 and/or multiple device identifiers and/or registered biometric data may be included in a data signal, for instances where multiple consumers 106 and/or computing devices 114 may be registered with a transaction account. The receiving device 202 may also be configured to receive data signals from issuer systems 104 that are superimposed or otherwise encoded with confirmation requests, which may include a transaction identifier, transaction data values, and one or more device identifiers. The receiving device 202 may be further configured to receive data signals from computing devices 114 that are superimposed or otherwise encoded with confirmation messages, which may indication confirmation or denial of a suspected transaction and may include a transaction identifier and captured biometric data. In some embodiments, the receiving device 202 may be further configured to receive one or more public keys as part of a key exchange with a computing device 114 during registration of the computing device 114.

The processing server 102 may also include a communication module 204. The communication module 204 may be configured to transmit data between modules, engines, databases, memories, and other components of the processing server 102 for use in performing the functions discussed herein. The communication module 204 may be comprised of one or more communication types and utilize various communication methods for communications within a computing device. For example, the communication module 204 may be comprised of a bus, contact pin connectors, wires, etc. In some embodiments, the communication module 204 may also be configured to communicate between internal components of the processing server 102 and external components of the processing server 102, such as externally connected databases, display devices, input devices, etc. The processing server 102 may also include a processing device. The processing device may be configured to perform the functions of the processing server 102 discussed herein as will be apparent to persons having skill in the relevant art. In some embodiments, the processing device may include and/or be comprised of a plurality of engines and/or modules specially configured to perform one or more functions of the processing device, such as a querying module 210, verification module 212, generation module 214, etc. As used herein, the term “module” may be software or hardware particularly programmed to receive an input, perform one or more processes using the input, and provide an output. The input, output, and processes performed by various modules will be apparent to one skilled in the art based upon the present disclosure.

The processing server 102 may include a device database 206. The device database 206 may be configured to store a plurality of device profiles 208 using a suitable data storage format and schema. The device database 206 may be a relational database that utilizes structured query language for the storage, identification, modifying, updating, accessing, etc. of structured data sets stored therein. Each device profile 208 may be a structured data set configured to store data related to a transaction account and/or computing device 114. Each device profile 208 may include at least one or more device identifiers associated with computing devices 114 registered for a transaction account and one or more sets of registered biometric data, each being associated with a consumer 106 registered for the transaction account. In some cases, a device identifier may be associated with registered biometric data such that the corresponding consumer 106 must use that specific computing device 114 for confirming a suspected transaction. In some embodiments, a device profile 208 may also include one or more encryption keys, which may be associated with a device identifier and correspond to a key pair, with the corresponding key in the key pair being provisioned to the associated computing device 114.

The processing server 102 may include a querying module 210. The querying module 210 may be configured to execute queries on databases to identify information. The querying module 210 may receive one or more data values or query strings, and may execute a query string based thereon on an indicated database, such as the device database 206, to identify information stored therein. The querying module 210 may then output the identified information to an appropriate engine or module of the processing server 102 as necessary. The querying module 210 may, for example, execute a query on the device database 206 to identify a device profile 208 related to a transaction account for which a confirmation request is received as a result of a suspected transaction, where the device profile 208 includes the device identifier included in the confirmation request.

The processing server 102 may also include a verification module 212. The verification module 212 may be configured to verify data for use in performing the functions of the processing server 102 discussed herein. The verification module 212 may receive a set of data to be verified along with data to be used in the verification and/or an instruction related thereto, may perform the verification, and may output the result of the verification to another module or engine of the processing server 102. The verification module 212 may, for example, verify captured biometric data included in a confirmation message received from a computing device 114 by the receiving device 202 as being equivalent to registered biometric data included in a device profile 208 identified by the querying module 210. In some embodiments, the verification module 212 may also be configured to verify encryption values and/or shared keys for verification of a computing device 114 used in the confirmation of a suspect transaction.

The processing server 102 may also include a generation module 214. The generation module 214 may be configured to generate data and data messages for use by the processing server 102 in performing the functions discussed herein. The generation module 214 may receive instructions, which may include or be accompanied with data for use therewith, may generate data or data messages as instructed, and may output the generated data to another module or engine of the processing server 102. The generation module 214 may, for example, generate data messages for transmission to the computing device 114 and/or issuer system 104 for use in conveying data used in the confirmation of suspect transactions via biometric data. In some embodiments, the generation module 214 may be configured to generate encryption values and/or shared secrets using encryption keys stored in device profiles 208 for use in verification (e.g., by the verification module 212) of a computing device 114.

The processing server 102 may also include a transmitting device 216. The transmitting device 216 may be configured to transmit data over one or more networks via one or more network protocols. In some embodiments, the transmitting device 216 may be configured to transmit data over the payment rails, such as using specially configured infrastructure associated with payment networks 112 for the transmission of transaction messages that include sensitive financial data and information, such as identified payment credentials. In some instances, the transmitting device 216 may be configured to transmit data to issuer systems 104, computing devices 114, and other entities via alternative networks, such as the Internet. In some embodiments, the transmitting device 216 may be comprised of multiple devices, such as different transmitting devices for transmitting data over different networks, such as a first transmitting device for transmitting data over the payment rails and a second transmitting device for transmitting data over the Internet. The transmitting device 216 may electronically transmit data signals that have data superimposed that may be parsed by a receiving computing device. In some instances, the transmitting device 216 may include one or more modules for superimposing, encoding, or otherwise formatting data into data signals suitable for transmission.

The transmitting device 216 may be configured to electronically transmit data signals to computing devices 114 that may be superimposed or otherwise encoded with biometric requests, which may include a transaction identifier and transaction data values, and with data used in the registration of the computing device 114, such as one or more encryption keys of a key pair, such as a public key where the processing server 102 may retain the corresponding private key. The transmitting device 216 may also be configured to electronically transmit data signals to issuer systems 104 that may be superimposed or otherwise encoded with confirmation responses, which may include indications of confirmation or denial of a suspect transaction, indications of successful or unsuccessful verification of a consumer 106 and/or computing device 114, and a transaction identifier. The transmitting device 216 may also be configured to electronically transmit data signals to the issuer system 104 for use in registration of a computing device 114, such as communication data for forwarding to the computing device 114, data related to requested biometrics, etc.

The processing server 102 may also include a memory 218. The memory 218 may be configured to store data for use by the processing server 102 in performing the functions discussed herein. The memory 218 may be configured to store data using suitable data formatting methods and schema and may be any suitable type of memory, such as read-only memory, random access memory, etc. The memory 218 may include, for example, encryption keys and algorithms, communication protocols and standards, data formatting standards and protocols, program code for modules and application programs of the processing device, and other data that may be suitable for use by the processing server 102 in the performance of the functions disclosed herein as will be apparent to persons having skill in the relevant art. In some embodiments, the memory 218 may be comprised of or may otherwise include a relational database that utilizes structured query language for the storage, identification, modifying, updating, accessing, etc. of structured data sets stored therein.

### Process for Biometric Confirmation of Suspected Transactions

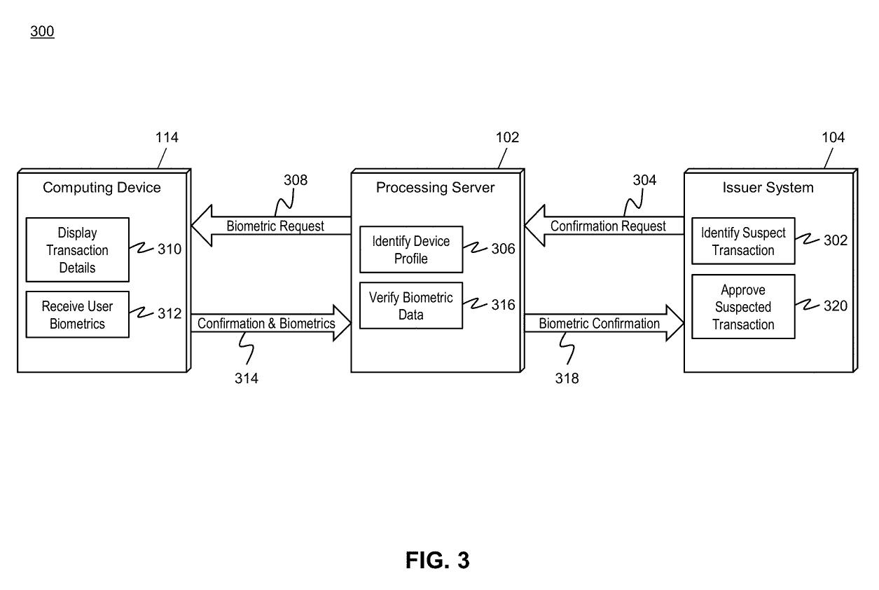

FIG. 3 illustrates a process 300 for the confirmation of a suspected transaction using biometric data via the system 100.

In step 302, the issuer system 104 may receive an authorization request for a payment transaction from the payment network 112 that the issuer system 104 identifies as being a suspect transaction. The identification of the authorization request as being for a suspect transaction may be based on data stored in the data elements included therein, as well as additional data that may be associated with the merchant involved in the payment transaction (e.g., a high risk merchant, merchant industry, geographic location, etc.) or the consumer involved in the payment transaction. Once the transaction is identified as suspect, then, in step 304, the issuer system 104 may electronically transmit a data signal to the processing server 102 that is superimposed or otherwise encoded with a confirmation request. The confirmation request may include at least a device identifier, a transaction identifier, and one or more transaction data values. In one embodiment, the transaction data values may include a currency type, transaction amount, merchant name, and transaction time.

The receiving device 202 of the processing server 102 may receive the confirmation request, and, in step 306, the querying module 210 of the processing server 102 may execute a query on the device database 206 to identify a device profile 208 related to the transaction account used in the payment transaction where the device profile 208 includes the device identifier included in the confirmation request. In step 308, the transmitting device 216 of the processing server 102 may electronically transmit a data signal to the computing device 114 associated with the device identifier that is superimposed or otherwise encoded with a biometric request, which may include at least the transaction identifier and transaction data values. In some instances, the biometric request may also include an indication that biometrics and confirmation are requested for a suspect transaction. In some embodiments, the biometric request may be transmitted to the computing device 114 via a push notification to the computing device 114. Methods for the transmission of a push notification to a computing device 114 will be apparent to persons having skill in the relevant art.

In step 310, the computing device 114 may display a prompt to a user (e.g., the consumer 106) that displays the transaction data values and prompts for confirmation or denial of the payment transaction and the capturing of biometric data. In step 312, the computing device 114 may capture biometric data from the user using any suitable method and device for capturing biometric data, as well as confirmation that the suspect transaction is genuine. The biometric data may be, for example, a fingerprint scan, retinal scan, facial scan, voice capture, etc., or a combination thereof. In step 314, the computing device 114 may electronically transmit a data signal to the processing server 102, to be received by the receiving device 202 of the processing server 102, that is superimposed or otherwise encoded with a confirmation message, the confirmation message comprising the transaction identifier, the indication of confirmation of the suspect transaction, and the captured biometric data. In some embodiments, the confirmation message may also include an encryption value generated by the computing device 114.

In step 316, the verification module 212 of the processing server 102 may verify that the captured biometric data captured from the user of the computing device 114 corresponds to the biometric data registered for the transaction account, as stored in the device profile 208 identified in step 306. In embodiments where the computing device 114 may supply an encryption key, step 316 may also include the generation (e.g., by the generation module 214 of the computing device 104) of another encryption value (e.g., using one or more encryption keys stored in the device profile 208) and the verification of equivalence of the two encryption values. Following the verification, in step 318 the transmitting device 216 of the processing server 102 may electronically transmit a data signal to the issuer system 104 that is superimposed or otherwise encoded with a biometric confirmation. The biometric confirmation may include at least the transaction identifier, the indication of confirmation of the suspect transaction, and the results of the verification of the biometric data (e.g., and of the computing device 114, if applicable). In step 320, the issuer system 104 may approve the suspect transaction based on the user's confirmation, and the successful verification of the user (e.g., and computing device 114, if applicable), if indicated as such in the biometric confirmation.

### Process for Biometric and Encryption Verification for a Suspect Transaction

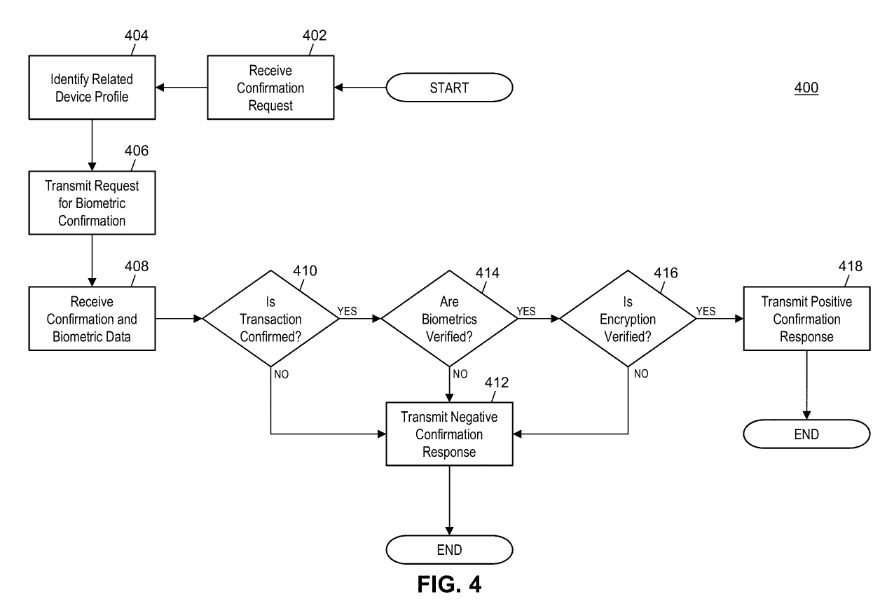

FIG. 4 illustrates a process 400 for the confirmation of a suspect transaction that includes authentication of an entity making the confirmation via biometric data, as well as authentication of the computing device 114 used to make the confirmation via encryption values.

In step 402, the receiving device 202 of the processing server 102 may receive a data signal superimposed or otherwise encoded with a confirmation request from an issuer system 104. The confirmation request may be related to a suspect transaction and may include at least a transaction identifier for the suspect transaction, one or more transaction data values associated with the suspect transaction, and at least one device identifier associated with the transaction account involved in the suspect transaction. In step 404, the querying module 210 of the processing server 102 may execute a query on the processing server 102 to identify a device profile 208 related to the involved transaction account, based on the inclusion of the device identifier included in the confirmation message.

In step 406, the transmitting device 216 of the processing server 102 may electronically transmit a data signal superimposed or otherwise encoded with a request for biometric confirmation to each computing device 114 associated with a device identifier included in the identified device profile 208. The request for biometric may include at least the transaction identifier and one or more transaction data values included in the confirmation request. In step 408, the receiving device 202 of the processing server 102 may receive a data signal superimposed or otherwise encoded with a confirmation message from one of the computing devices 114 that received the request for biometric confirmation. The confirmation message may include at least an indication of confirmation or denial of the suspect transaction, biometric data captured from a user of the computing device 114, and an encryption value generated by the computing device 114 using at least one encryption key, which may be part of a key pair where the corresponding key is stored in the identified device profile 208.

In step 410, the verification module 212 or other suitable module or engine of the processing server 102 may determine if the suspect transaction was confirmed by the user of the computing device 114. The determination may be based on the indication received in the confirmation message provided by the computing device 114. If the suspect transaction was not confirmed (e.g., was denied) by the user, then the process 400 may proceed to step 412 where the transmitting device 216 of the processing server 102 may electronically transmit a data signal back to the issuer system 104 that is superimposed or otherwise encoded with a negative confirmation response, which may indicate that the suspect transaction cannot be confirmed. In some instances, the negative confirmation response may indicate a reason, such as the declining of the suspect transaction via the computing device 114.

If, in step 410, it is determined that the user of the computing device 114 approved the suspect transaction, then, in step 414, the verification module 212 may determine if the biometric data captured by the computing device 114 can be successfully verified. Verification may include a comparison of the captured biometric data to the biometric data stored in the identified device profile 208. If verification is unsuccessful, then the process 400 may proceed to step 412, where the negative confirmation message is provided to the issuer system 104. In such an instance, the negative confirmation message may indicate that verification of the biometric data was unsuccessful, which may indicate a compromise of the computing device 114.

If, in step 414, verification of the captured biometric data is successful, then, in step 416, the verification module 212 may verify the encryption value included in the confirmation message. Verification of the encryption value may include the generation (e.g., by the generation module 214 of the processing server 102) of a second encryption value using one or more encryption keys stored in the identified device profile 208 (e.g., which may be associated with the computing device 114 that provided the confirmation message) and the comparison of the encryption value included in the confirmation message with the generated encryption value. If the verification is unsuccessful, then the process may proceed to step 412, where the negative confirmation message is provided to the issuer system 104. In such an instance, the negative confirmation message may indicate that verification of the computing device 114 was unsuccessful, which may indicate that an unauthorized computing device 114 attempted the confirmation. If the verification is successful, then the process may proceed to step 418, where a positive confirmation response may be electronically transmitted by the transmitting device 216 to the processing server 102. The positive confirmation response may indicate that the consumer 106 provided confirmation, that verification of biometric data provided by the consumer 106 was successful, and verification of the computing device 114 used in the confirmation was also successful.

### Exemplary Method for Confirmation of a Suspect Transaction Using Biometric Data

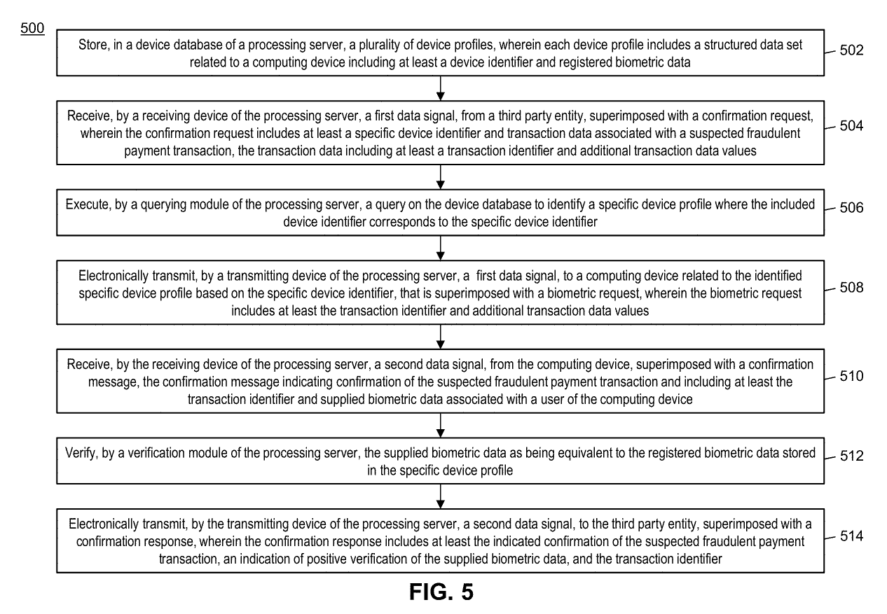

FIG. 5 illustrates a method 500 for the confirmation of a suspect electronic payment transaction using biometric data captured from a consumer involved in the payment transaction via a computing device associated with a transaction account used in the suspect payment transaction.

In step 502, a plurality of device profiles (e.g., device profiles 208) may be stored in a device database (e.g., the device database 206) of a processing server (e.g., the processing server 102), wherein each device profile includes a structured data set related to a computing device (e.g., a computing device 114) including at last a device identifier and registered biometric data. In step 504, a first data signal may be received by a receiving device (e.g., the receiving device 202) of the processing server from a third party entity (e.g., the issuer system 104), where the data signal is superimposed with a confirmation request, the confirmation request including at least a specific device identifier and transaction data associated with a suspected fraudulent payment transaction, where the transaction data includes at least a transaction identifier and additional transaction data values.

In step 506, a query may be executed by a querying module (e.g. the querying module 210) of the processing server on the device database to identify a specific device profile where the included device identifier corresponds to the specific device identifier. In step 508, a first data signal may be electronically transmitted by a transmitting device (e.g., the transmitting device 216) of the processing server to a computing device related to the identified specific device profile based on the specific device identifier that is superimposed with a biometric request, wherein the biometric request includes at least the transaction identifier and additional transaction data values. In step 510, the receiving device of the processing server may receive a second data signal from the computing device superimposed with a confirmation message, wherein the confirmation message indicates confirmation of the suspected fraudulent payment transaction and includes at least the transaction identifier and supplied biometric data associated with a user (e.g., the consumer 106) of the computing device.

In step 512, the supplied biometric data may be verified by a verification module (e.g., the verification module 212) of the processing server as being equivalent to the registered biometric data stored in the specific device profile. In step 514, a second data signal may be electronically transmitted to the third party entity by the transmitting device of the processing server, the data signal being superimposed with a confirmation response, wherein the confirmation response includes at least the indicated confirmation of the suspected fraudulent payment transaction, an indication of the positive verification of the supplied biometric data, and the transaction identifier.

In some embodiments, the additional transaction data values may be displayed to the user of the computing device related to the identified specific device profile. In one embodiment, the additional transaction data values may include at least one of: transaction amount, merchant name, transaction time, transaction date, and currency type. In some embodiments, the registered biometric data may include at least one of: fingerprint data, retinal scan data, facial scan data, and voice recognition data.

In one embodiment, the method 500 may further include verifying, by the verification module of the processing server, the confirmation message as received from the computing device related to the specific device profile, wherein the confirmation message further includes an encryption value generated by the computing device using a first key of a key pair, the specific device profile further includes a second key corresponding to the first key in the key pair, and verification of the confirmation message includes verifying the encryption value included in the confirmation message using the second key included in the specific device profile. In a further embodiment, the method 500 may even further include: generating, by a generation module (e.g., the generation module 214) of the processing server, a second encryption value using the second key included in the specific device profile, wherein verifying the encryption value includes comparing the generated second encryption value to the encryption value included in the confirmation message.

In some embodiments, the biometric request may be electronically transmitted as a push notification to the computing device. In one embodiment, the third party entity may not possess or receive registered biometric data or the supplied biometric data. In some embodiments, the confirmation request is received prior to approval or denial of the suspected fraudulent payment transaction.

### Payment Transaction Processing System and Process

FIG. 6 illustrates a transaction processing system and a process 600 for the processing of payment transactions in the system, which may include the processing of thousands, millions, or even billions of transactions during a given period (e.g., hourly, daily, weekly, etc.). The process 600 and steps included therein may be performed by one or more components of the system 100 discussed above, such as the processing server 102, issuer system 104, consumer 106, payment instrument 108, merchant system 110, payment network 112, computing device 114, etc. The processing of payment transactions using the system and process 600 illustrated in FIG. 6 and discussed below may utilize the payment rails, which may be comprised of the computing devices and infrastructure utilized to perform the steps of the process 600 as specially configured and programmed by the entities discussed below, including the transaction processing server 612, which may be associated with one or more payment networks configured to processing payment transactions. It will be apparent to persons having skill in the relevant art that the process 600 may be incorporated into the processes illustrated in FIGS. 3-5, discussed above, with respect to the step or steps involved in the processing of a payment transaction. In addition, the entities discussed herein for performing the process 600 may include one or more computing devices or systems configured to perform the functions discussed below. For instance, the merchant 606 may be comprised of one or more point of sale devices, a local communication network, a computing server, and other devices configured to perform the functions discussed below.

In step 620, an issuing financial institution 602 may issue a payment card or other suitable payment instrument to a consumer 604. The issuing financial institution may be a financial institution, such as a bank, or other suitable type of entity that administers and manages payment accounts and/or payment instruments for use with payment accounts that can be used to fund payment transactions. The consumer 604 may have a transaction account with the issuing financial institution 602 for which the issued payment card is associated, such that, when used in a payment transaction, the payment transaction is funded by the associated transaction account. In some embodiments, the payment card may be issued to the consumer 604 physically. In other embodiments, the payment card may be a virtual payment card or otherwise provisioned to the consumer 604 in an electronic format.

In step 622, the consumer 604 may present the issued payment card to a merchant 606 for use in funding a payment transaction. The merchant 606 may be a business, another consumer, or any entity that may engage in a payment transaction with the consumer 604. The payment card may be presented by the consumer 604 via providing the physical card to the merchant 606, electronically transmitting (e.g., via near field communication, wireless transmission, or other suitable electronic transmission type and protocol) payment details for the payment card, or initiating transmission of payment details to the merchant 606 via a third party. The merchant 606 may receive the payment details (e.g., via the electronic transmission, via reading them from a physical payment card, etc.), which may include at least a transaction account number associated with the payment card and/or associated transaction account. In some instances, the payment details may include one or more application cryptograms, which may be used in the processing of the payment transaction.

In step 624, the merchant 606 may enter transaction details into a point of sale computing system. The transaction details may include the payment details provided by the consumer 604 associated with the payment card and additional details associated with the transaction, such as a transaction amount, time and/or date, product data, offer data, loyalty data, reward data, merchant data, consumer data, point of sale data, etc. Transaction details may be entered into the point of sale system of the merchant 606 via one or more input devices, such as an optical bar code scanner configured to scan product bar codes, a keyboard configured to receive product codes input by a user, etc. The merchant point of sale system may be a specifically configured computing device and/or special purpose computing device intended for the purpose of processing electronic financial transactions and communicating with a payment network (e.g., via the payment rails). The merchant point of sale system may be an electronic device upon which a point of sale system application is run, wherein the application causes the electronic device to receive and communicated electronic financial transaction information to a payment network. In some embodiments, the merchant 606 may be an online retailer in an e-commerce transaction. In such embodiments, the transaction details may be entered in a shopping cart or other repository for storing transaction data in an electronic transaction as will be apparent to persons having skill in the relevant art.

In step 626, the merchant 606 may electronically transmit a data signal superimposed with transaction data to a gateway processor 608. The gateway processor 608 may be an entity configured to receive transaction details from a merchant 606 for formatting and transmission to an acquiring financial institution 610. In some instances, a gateway processor 608 may be associated with a plurality of merchants 606 and a plurality of acquiring financial institutions 610. In such instances, the gateway processor 608 may receive transaction details for a plurality of different transactions involving various merchants, which may be forwarded on to appropriate acquiring financial institutions 610. By having relationships with multiple acquiring financial institutions 610 and having the requisite infrastructure to communicate with financial institutions using the payment rails, such as using application programming interfaces associated with the gateway processor 608 or financial institutions used for the submission, receipt, and retrieval of data, a gateway processor 608 may act as an intermediary for a merchant 606 to be able to conduct payment transactions via a single communication channel and format with the gateway processor 608, without having to maintain relationships with multiple acquiring financial institutions 610 and payment processors and the hardware associated thereto. Acquiring financial institutions 610 may be financial institutions, such as banks, or other entities that administers and manages payment accounts and/or payment instruments for use with payment accounts. In some instances, acquiring financial institutions 610 may manage transaction accounts for merchants 606. In some cases, a single financial institution may operate as both an issuing financial institution 602 and an acquiring financial institution 610.

The data signal transmitted from the merchant 606 to the gateway processor 608 may be superimposed with the transaction details for the payment transaction, which may be formatted based on one or more standards. In some embodiments, the standards may be set forth by the gateway processor 608, which may use a unique, proprietary format for the transmission of transaction data to/from the gateway processor 608. In other embodiments, a public standard may be used, such as the International Organization for Standardization's ISO 8683 standard. The standard may indicate the types of data that may be included, the formatting of the data, how the data is to be stored and transmitted, and other criteria for the transmission of the transaction data to the gateway processor 608.

In step 628, the gateway processor 608 may parse the transaction data signal to obtain the transaction data superimposed thereon and may format the transaction data as necessary. The formatting of the transaction data may be performed by the gateway processor 608 based on the proprietary standards of the gateway processor 608 or an acquiring financial institution 610 associated with the payment transaction. The proprietary standards may specify the type of data included in the transaction data and the format for storage and transmission of the data. The acquiring financial institution 610 may be identified by the gateway processor 608 using the transaction data, such as by parsing the transaction data (e.g., deconstructing into data elements) to obtain an account identifier included therein associated with the acquiring financial institution 610. In some instances, the gateway processor 608 may then format the transaction data based on the identified acquiring financial institution 610, such as to comply with standards of formatting specified by the acquiring financial institution 610. In some embodiments, the identified acquiring financial institution 610 may be associated with the merchant 606 involved in the payment transaction, and, in some cases, may manage a transaction account associated with the merchant 606.

In step 630, the gateway processor 608 may electronically transmit a data signal superimposed with the formatted transaction data to the identified acquiring financial institution 610. The acquiring financial institution 610 may receive the data signal and parse the signal to obtain the formatted transaction data superimposed thereon. In step 632, the acquiring financial institution may generate an authorization request for the payment transaction based on the formatted transaction data. The authorization request may be a specially formatted transaction message that is formatted pursuant to one or more standards, such as the ISO 8683 standard and standards set forth by a payment processor used to process the payment transaction, such as a payment network. The authorization request may be a transaction message that includes a message type indicator indicative of an authorization request, which may indicate that the merchant 606 involved in the payment transaction is requesting payment or a promise of payment from the issuing financial institution 602 for the transaction. The authorization request may include a plurality of data elements, each data element being configured to store data as set forth in the associated standards, such as for storing an account number, application cryptogram, transaction amount, issuing financial institution 602 information, etc.

In step 634, the acquiring financial institution 610 may electronically transmit the authorization request to a transaction processing server 612 for processing. The transaction processing server 612 may be comprised of one or more computing devices as part of a payment network configured to process payment transactions. In some embodiments, the authorization request may be transmitted by a transaction processor at the acquiring financial institution 610 or other entity associated with the acquiring financial institution. The transaction processor may be one or more computing devices that include a plurality of communication channels for communication with the transaction processing server 612 for the transmission of transaction messages and other data to and from the transaction processing server 612. In some embodiments, the payment network associated with the transaction processing server 612 may own or operate each transaction processor such that the payment network may maintain control over the communication of transaction messages to and from the transaction processing server 612 for network and informational security.

In step 636, the transaction processing server 612 may perform value-added services for the payment transaction. Value-added services may be services specified by the issuing financial institution 602 that may provide additional value to the issuing financial institution 602 or the consumer 604 in the processing of payment transactions. Value-added services may include, for example, fraud scoring, transaction or account controls, account number mapping, offer redemption, loyalty processing, etc. For instance, when the transaction processing server 612 receives the transaction, a fraud score for the transaction may be calculated based on the data included therein and one or more fraud scoring algorithms and/or engines. In some instances, the transaction processing server 612 may first identify the issuing financial institution 602 associated with the transaction, and then identify any services indicated by the issuing financial institution 602 to be performed. The issuing financial institution 602 may be identified, for example, by data included in a specific data element included in the authorization request, such as an issuer identification number. In another example, the issuing financial institution 602 may be identified by the primary account number stored in the authorization request, such as by using a portion of the primary account number (e.g., a bank identification number) for identification.

In step 638, the transaction processing server 612 may electronically transmit the authorization request to the issuing financial institution 602. In some instances, the authorization request may be modified, or additional data included in or transmitted accompanying the authorization request as a result of the performance of value-added services by the transaction processing server 612. In some embodiments, the authorization request may be transmitted to a transaction processor (e.g., owned or operated by the transaction processing server 612) situated at the issuing financial institution 602 or an entity associated thereof, which may forward the authorization request to the issuing financial institution 602.

In step 640, the issuing financial institution 602 may authorize the transaction account for payment of the payment transaction. The authorization may be based on an available credit amount for the transaction account and the transaction amount for the payment transaction, fraud scores provided by the transaction processing server 612, and other considerations that will be apparent to persons having skill in the relevant art. The issuing financial institution 602 may modify the authorization request to include a response code indicating approval (e.g., or denial if the transaction is to be denied) of the payment transaction. The issuing financial institution 602 may also modify a message type indicator for the transaction message to indicate that the transaction message is changed to be an authorization response. In step 642, the issuing financial institution 602 may transmit (e.g., via a transaction processor) the authorization response to the transaction processing server 612.

In step 644, the transaction processing server 612 may forward the authorization response to the acquiring financial institution 610 (e.g., via a transaction processor). In step 646, the acquiring financial institution may generate a response message indicating approval or denial of the payment transaction as indicated in the response code of the authorization response, and may transmit the response message to the gateway processor 608 using the standards and protocols set forth by the gateway processor 608. In step 648, the gateway processor 608 may forward the response message to the merchant 606 using the appropriate standards and protocols. In step 650, assuming the transaction was approved, the merchant 606 may then provide the products purchased by the consumer 604 as part of the payment transaction to the consumer 604.

In some embodiments, once the process 600 has completed, payment from the issuing financial institution 602 to the acquiring financial institution 610 may be performed. In some instances, the payment may be made immediately or within one business day. In other instances, the payment may be made after a period of time, and in response to the submission of a clearing request from the acquiring financial institution 610 to the issuing financial institution 602 via the transaction processing server 602. In such instances, clearing requests for multiple payment transactions may be aggregated into a single clearing request, which may be used by the transaction processing server 612 to identify overall payments to be made by whom and to whom for settlement of payment transactions.

In some instances, the system may also be configured to perform the processing of payment transactions in instances where communication paths may be unavailable. For example, if the issuing financial institution is unavailable to perform authorization of the transaction account (e.g., in step 640), the transaction processing server 612 may be configured to perform authorization of transactions on behalf of the issuing financial institution 602. Such actions may be referred to as “stand-in processing,” where the transaction processing server “stands in” as the issuing financial institution 602. In such instances, the transaction processing server 612 may utilize rules set forth by the issuing financial institution 602 to determine approval or denial of the payment transaction, and may modify the transaction message accordingly prior to forwarding to the acquiring financial institution 610 in step 644. The transaction processing server 612 may retain data associated with transactions for which the transaction processing server 612 stands in, and may transmit the retained data to the issuing financial institution 602 once communication is reestablished. The issuing financial institution 602 may then process transaction accounts accordingly to accommodate for the time of lost communication.

In another example, if the transaction processing server 612 is unavailable for submission of the authorization request by the acquiring financial institution 610, then the transaction processor at the acquiring financial institution 610 may be configured to perform the processing of the transaction processing server 612 and the issuing financial institution 602. The transaction processor may include rules and data suitable for use in making a determination of approval or denial of the payment transaction based on the data included therein. For instance, the issuing financial institution 602 and/or transaction processing server 612 may set limits on transaction type, transaction amount, etc. that may be stored in the transaction processor and used to determine approval or denial of a payment transaction based thereon. In such instances, the acquiring financial institution 610 may receive an authorization response for the payment transaction even if the transaction processing server 612 is unavailable, ensuring that transactions are processed and no downtime is experienced even in instances where communication is unavailable. In such cases, the transaction processor may store transaction details for the payment transactions, which may be transmitted to the transaction processing server 612 (e.g., and from there to the associated issuing financial institutions 602) once communication is reestablished.

In some embodiments, transaction processors may be configured to include a plurality of different communication channels, which may utilize multiple communication cards and/or devices, to communicate with the transaction processing server 612 for the sending and receiving of transaction messages. For example, a transaction processor may be comprised of multiple computing devices, each having multiple communication ports that are connected to the transaction processing server 612. In such embodiments, the transaction processor may cycle through the communication channels when transmitting transaction messages to the transaction processing server 612, to alleviate network congestion and ensure faster, smoother communications. Furthermore, in instances where a communication channel may be interrupted or otherwise unavailable, alternative communication channels may thereby be available, to further increase the uptime of the network.

In some embodiments, transaction processors may be configured to communicate directly with other transaction processors. For example, a transaction processor at an acquiring financial institution 610 may identify that an authorization request involves an issuing financial institution 602 (e.g., via the bank identification number included in the transaction message) for which no value-added services are required. The transaction processor at the acquiring financial institution 610 may then transmit the authorization request directly to the transaction processor at the issuing financial institution 602 (e.g., without the authorization request passing through the transaction processing server 612), where the issuing financial institution 602 may process the transaction accordingly.

The methods discussed above for the processing of payment transactions that utilize multiple methods of communication using multiple communication channels, and includes fail safes to provide for the processing of payment transactions at multiple points in the process and at multiple locations in the system, as well as redundancies to ensure that communications arrive at their destination successfully even in instances of interruptions, may provide for a robust system that ensures that payment transactions are always processed successfully with minimal error and interruption. This advanced network and its infrastructure and topology may be commonly referred to as “payment rails,” where transaction data may be submitted to the payment rails from merchants at millions of different points of sale, to be routed through the infrastructure to the appropriate transaction processing servers 612 for processing. The payment rails may be such that a general purpose computing device may be unable to properly format or submit communications to the rails, without specialized programming and/or configuration. Through the specialized purposing of a computing device, the computing device may be configured to submit transaction data to the appropriate entity (e.g., a gateway processor 608, acquiring financial institution 610, etc.) for processing using this advanced network, and to quickly and efficiently receive a response regarding the ability for a consumer 604 to fund the payment transaction.

### Computer System Architecture

FIG. 7 illustrates a computer system 700 in which embodiments of the present disclosure, or portions thereof, may be implemented as computer-readable code. For example, the processing server 102 of FIG. 1 may be implemented in the computer system 700 using hardware, software, firmware, non-transitory computer readable media having instructions stored thereon, or a combination thereof and may be implemented in one or more computer systems or other processing systems. Hardware, software, or any combination thereof may embody modules and components used to implement the methods of FIGS. 3-6.

If programmable logic is used, such logic may execute on a commercially available processing platform configured by executable software code to become a specific purpose computer or a special purpose device (e.g., programmable logic array, application-specific integrated circuit, etc.). A person having ordinary skill in the art may appreciate that embodiments of the disclosed subject matter can be practiced with various computer system configurations, including multi-core multiprocessor systems, minicomputers, mainframe computers, computers linked or clustered with distributed functions, as well as pervasive or miniature computers that may be embedded into virtually any device. For instance, at least one processor device and a memory may be used to implement the above described embodiments.

A processor unit or device as discussed herein may be a single processor, a plurality of processors, or combinations thereof. Processor devices may have one or more processor “cores.” The terms “computer program medium,” “non-transitory computer readable medium,” and “computer usable medium” as discussed herein are used to generally refer to tangible media such as a removable storage unit 718, a removable storage unit 722, and a hard disk installed in hard disk drive 712.

Various embodiments of the present disclosure are described in terms of this example computer system 700. After reading this description, it will become apparent to a person skilled in the relevant art how to implement the present disclosure using other computer systems and/or computer architectures. Although operations may be described as a sequential process, some of the operations may in fact be performed in parallel, concurrently, and/or in a distributed environment, and with program code stored locally or remotely for access by single or multi-processor machines. In addition, in some embodiments the order of operations may be rearranged without departing from the spirit of the disclosed subject matter.

Processor device 704 may be a special purpose or a general purpose processor device specifically configured to perform the functions discussed herein. The processor device 704 may be connected to a communications infrastructure 706, such as a bus, message queue, network, multi-core message-passing scheme, etc. The network may be any network suitable for performing the functions as disclosed herein and may include a local area network (LAN), a wide area network (WAN), a wireless network (e.g., WiFi), a mobile communication network, a satellite network, the Internet, fiber optic, coaxial cable, infrared, radio frequency (RF), or any combination thereof. Other suitable network types and configurations will be apparent to persons having skill in the relevant art. The computer system 700 may also include a main memory 708 (e.g., random access memory, read-only memory, etc.), and may also include a secondary memory 710. The secondary memory 710 may include the hard disk drive 712 and a removable storage drive 714, such as a floppy disk drive, a magnetic tape drive, an optical disk drive, a flash memory, etc.

The removable storage drive 714 may read from and/or write to the removable storage unit 718 in a well-known manner. The removable storage unit 718 may include a removable storage media that may be read by and written to by the removable storage drive 714. For example, if the removable storage drive 714 is a floppy disk drive or universal serial bus port, the removable storage unit 718 may be a floppy disk or portable flash drive, respectively. In one embodiment, the removable storage unit 718 may be non-transitory computer readable recording media.

In some embodiments, the secondary memory 710 may include alternative means for allowing computer programs or other instructions to be loaded into the computer system 700, for example, the removable storage unit 722 and an interface 720. Examples of such means may include a program cartridge and cartridge interface (e.g., as found in video game systems), a removable memory chip (e.g., EEPROM, PROM, etc.) and associated socket, and other removable storage units 722 and interfaces 720 as will be apparent to persons having skill in the relevant art.

Data stored in the computer system 700 (e.g., in the main memory 708 and/or the secondary memory 710) may be stored on any type of suitable computer readable media, such as optical storage (e.g., a compact disc, digital versatile disc, Blu-ray disc, etc.) or magnetic tape storage (e.g., a hard disk drive). The data may be configured in any type of suitable database configuration, such as a relational database, a structured query language (SQL) database, a distributed database, an object database, etc. Suitable configurations and storage types will be apparent to persons having skill in the relevant art.

The computer system 700 may also include a communications interface 724. The communications interface 724 may be configured to allow software and data to be transferred between the computer system 700 and external devices. Exemplary communications interfaces 724 may include a modem, a network interface (e.g., an Ethernet card), a communications port, a PCMCIA slot and card, etc. Software and data transferred via the communications interface 724 may be in the form of signals, which may be electronic, electromagnetic, optical, or other signals as will be apparent to persons having skill in the relevant art. The signals may travel via a communications path 726, which may be configured to carry the signals and may be implemented using wire, cable, fiber optics, a phone line, a cellular phone link, a radio frequency link, etc.

The computer system 700 may further include a display interface 702. The display interface 702 may be configured to allow data to be transferred between the computer system 700 and external display 730. Exemplary display interfaces 702 may include high-definition multimedia interface (HDMI), digital visual interface (DVI), video graphics array (VGA), etc. The display 730 may be any suitable type of display for displaying data transmitted via the display interface 702 of the computer system 700, including a cathode ray tube (CRT) display, liquid crystal display (LCD), light-emitting diode (LED) display, capacitive touch display, thin-film transistor (TFT) display, etc.

Computer program medium and computer usable medium may refer to memories, such as the main memory 708 and secondary memory 710, which may be memory semiconductors (e.g., DRAMs, etc.). These computer program products may be means for providing software to the computer system 700. Computer programs (e.g., computer control logic) may be stored in the main memory 708 and/or the secondary memory 710. Computer programs may also be received via the communications interface 724. Such computer programs, when executed, may enable computer system 700 to implement the present methods as discussed herein. In particular, the computer programs, when executed, may enable processor device 704 to implement the methods illustrated by FIGS. 3-6, as discussed herein. Accordingly, such computer programs may represent controllers of the computer system 700. Where the present disclosure is implemented using software, the software may be stored in a computer program product and loaded into the computer system 700 using the removable storage drive 714, interface 720, and hard disk drive 712, or communications interface 724.

The processor device 704 may comprise one or more modules or engines configured to perform the functions of the computer system 700. Each of the modules or engines may be implemented using hardware and, in some instances, may also utilize software, such as corresponding to program code and/or programs stored in the main memory 708 or secondary memory 710. In such instances, program code may be compiled by the processor device 704 (e.g., by a compiling module or engine) prior to execution by the hardware of the computer system 700. For example, the program code may be source code written in a programming language that is translated into a lower level language, such as assembly language or machine code, for execution by the processor device 704 and/or any additional hardware components of the computer system 700. The process of compiling may include the use of lexical analysis, preprocessing, parsing, semantic analysis, syntax-directed translation, code generation, code optimization, and any other techniques that may be suitable for translation of program code into a lower level language suitable for controlling the computer system 700 to perform the functions disclosed herein. It will be apparent to persons having skill in the relevant art that such processes result in the computer system 700 being a specially configured computer system 700 uniquely programmed to perform the functions discussed above.

Techniques consistent with the present disclosure provide, among other features, systems and methods for confirmation of a suspect transaction using biometric data. While various exemplary embodiments of the disclosed system and method have been described above it should be understood that they have been presented for purposes of example only, not limitations. It is not exhaustive and does not limit the disclosure to the precise form disclosed. Modifications and variations are possible in light of the above teachings or may be acquired from practicing of the disclosure, without departing from the breadth or scope.

What is claimed is:

1. A method for confirmation of a suspect transaction using biometric data, comprising:
storing, in a device database of a processing server, a plurality of device profiles, wherein each device profile includes a structured data set related to a computing device including at least a device identifier and registered biometric data;
receiving, by a receiving device of the processing server, a first data signal, from a third party entity, superimposed with a confirmation request, wherein the confirmation request includes at least a specific device identifier and transaction data associated with a suspected fraudulent payment transaction, the transaction data including at least a transaction identifier and additional transaction data values;
executing, by a querying module of the processing server, a query on the device database to identify a specific device profile where the included device identifier corresponds to the specific device identifier;
electronically transmitting, by a transmitting device of the processing server, a first data signal, to a computing device related to the identified specific device profile based on the specific device identifier, that is superimposed with a biometric request, wherein the biometric request includes at least the transaction identifier and additional transaction data values;
receiving, by the receiving device of the processing server, a second data signal, from the computing device, superimposed with a confirmation message, the confirmation message indicating confirmation of the suspected fraudulent payment transaction and including at least the transaction identifier and supplied biometric data associated with a user of the computing device;
verifying, by a verification module of the processing server, the supplied biometric data as being equivalent to the registered biometric data stored in the specific device profile; and
electronically transmitting, by the transmitting device of the processing server, a second data signal, to the third party entity, superimposed with a confirmation response, wherein the confirmation response includes at least the indicated confirmation of the suspected fraudulent payment transaction, an indication of positive verification of the supplied biometric data, and the transaction identifier.

2. The method of claim 1, wherein the additional transaction values are displayed to the user of the computing device related to the identified specific device profile.

3. The method of claim 1, wherein the additional transaction values include at least one of: transaction amount, merchant name, transaction time, transaction date, and currency type.

4. The method of claim 1, wherein the registered biometric data includes at least one of: fingerprint data, retinal scan data, facial scan data, and voice recognition data.

5. The method of claim 1, further comprising:
verifying, by the verification module of the processing server, the confirmation message as received from the computing device related to the specific device profile, wherein
the confirmation message further includes an encryption value generated by the computing device using a first key of a key pair;
the specific device profile further includes a second key corresponding to the first key in the key pair; and
verification of the confirmation message includes verifying the encryption value included in the confirmation message using the second key included in the specific device profile.

6. The method of claim 5, further comprising:
generating, by a generation module of the processing server, a second encryption value using the second key included in the specific device profile, wherein
verifying the encryption value includes comparing the generated second encryption value to the encryption value included in the confirmation message.

7. The method of claim 1, wherein the biometric request is electronically transmitted as a push notification to the computing device.

8. The method of claim 1, wherein the third party entity does not possess or receive registered biometric data or the supplied biometric data.

9. The method of claim 1, wherein the confirmation request is received prior to approval or denial of the suspected fraudulent payment transaction.

10. The method of claim 1, wherein
the specific device profile includes a plurality of device identifiers, the plurality of device identifiers including the specific device identifier,
the first data signal is electronically transmitted to a computing device associated with each of the plurality of device identifiers, and
the second data signal is received from one of the computing devices associated with each of the plurality of device identifiers.

11. A system for confirmation of a suspect transaction using biometric data, comprising:
a verification module of a processing server;
a device database of the processing server configured to store a plurality of device profiles, wherein each device profile includes a structured data set related to a computing device including at least a device identifier and registered biometric data;
a receiving device of the processing server configured to receive a first data signal, from a third party entity, superimposed with a confirmation request, wherein the confirmation request includes at least a specific device identifier and transaction data associated with a suspected fraudulent payment transaction, the transaction data including at least a transaction identifier and additional transaction data values;
a querying module of the processing server configured to execute a query on the device database to identify a specific device profile where the included device identifier corresponds to the specific device identifier; and
a transmitting device of the processing server configured to electronically transmit a first data signal, to a computing device related to the identified specific device profile based on the specific device identifier, that is superimposed with a biometric request, wherein the biometric request includes at least the transaction identifier and additional transaction data values, wherein
the receiving device of the processing server is further configured to receive a second data signal, from the computing device, superimposed with a confirmation message, the confirmation message indicating confirmation of the suspected fraudulent payment transaction and including at least the transaction identifier and supplied biometric data associated with a user of the computing device,
the verification module of the processing server is configured to verify the supplied biometric data as being equivalent to the registered biometric data stored in the specific device profile, and
the transmitting device of the processing server is further configured to electronically transmit a second data signal, to the third party entity, superimposed with a confirmation response, wherein the confirmation response includes at least the indicated confirmation of the suspected fraudulent payment transaction, an indication of positive verification of the supplied biometric data, and the transaction identifier.

12. The system of claim 11, wherein the additional transaction values are displayed to the user of the computing device related to the identified specific device profile.

13. The system of claim 11, wherein the additional transaction values include at least one of: transaction amount, merchant name, transaction time, transaction date, and currency type.

14. The system of claim 11, wherein the registered biometric data includes at least one of: fingerprint data, retinal scan data, facial scan data, and voice recognition data.

15. The system of claim 11, wherein
the confirmation message further includes an encryption value generated by the computing device using a first key of a key pair,
the specific device profile further includes a second key corresponding to the first key in the key pair, and
the verification module of the processing server is further configured to verify the confirmation message as received from the computing device related to the specific device profile by verifying the encryption value included in the confirmation message using the second key included in the specific device profile.

16. The system of claim 15, further comprising:
a generation module of the processing server configured to generate a second encryption value using the second key included in the specific device profile, wherein
verifying the encryption value includes comparing the generated second encryption value to the encryption value included in the confirmation message.

17. The system of claim 11, wherein the biometric request is electronically transmitted as a push notification to the computing device.

18. The system of claim 11, wherein the third party entity does not possess or receive registered biometric data or the supplied biometric data.

19. The system of claim 11, wherein the confirmation request is received prior to approval or denial of the suspected fraudulent payment transaction.

20. The system of claim 11, wherein
the specific device profile includes a plurality of device identifiers, the plurality of device identifiers including the specific device identifier,
the first data signal is electronically transmitted to a computing device associated with each of the plurality of device identifiers, and
the second data signal is received from one of the computing devices associated with each of the plurality of device identifiers.
